(19) United States
(12) Patent Application Publication
(10) Pub. No.: US 2023/0109341 A1
(43) Pub. Date: Apr. 6, 2023

(54) HEAT EXCHANGER AND METHOD FOR REFUELING A VEHICLE

(71) Applicant: Schmöle GmbH, Frondenberg (DE)

(72) Inventors: Till NEUMANN, Iserlohn (DE); Alexander HARDER, Wuppertal (DE)

(21) Appl. No.: 17/957,229

(22) Filed: Sep. 30, 2022

(30) Foreign Application Priority Data
Oct. 4, 2021 (DE) 10 2021 125 688.7

(51) Int. Cl. F17C 5/06; F17C 13/10

(52) U.S. Cl. CPC F17C 5/06; F17C 13/10; F17C 2221/012; F17C 2227/0304; F17C 2227/039; F17C 2260/032; F17C 2265/065; F17C 2227/0341

(57) ABSTRACT

A heat exchanger, including a heat exchanger tube for guiding a first medium in its interior, and also at least one connection for a second medium, wherein the region around the heat exchanger tube is provided by an open-pored, in particular solid, material, preferably a body of such a material, into which the second medium in particular can enter.

The invention relates according to a first aspect to a heat exchanger.

Heat exchangers are well known from many fields of technology.

In particular, they are also used in the refueling of vehicles with hydrogen.

The procedure is thereby such that hydrogen, which can be introduced into the tank of a vehicle by way of a delivery nozzle, or delivery gun, must be cooled down. The reason for this is that, during the process of introducing the hydrogen from the gas pump into the tank of the vehicle, undesirable compression-related heating of the hydrogen typically takes place, which is to be equalized by the measure of prior cooling.

In the prior art, at least two different solutions are known: According to a first embodiment, there is in the region of a hydrogen fueling station, under the ground, a very large aluminum block with a diameter of several meters for cold storage.

Because such an aluminum block involves a very large structural outlay, there are alternatives in which the heat exchanger is integrated in the gas pump. The heat exchangers are then typically so-called plate heat exchangers through which the hydrogen is passed, wherein it flows in an alternating manner through every second chamber formed between the plates. A refrigerant is passed through the plate heat exchanger in the opposite direction, flowing through the respective other chambers.

However, the costs for the production thereof are nevertheless to be regarded as extremely high, in particular because, in order to achieve sufficient tightness, the plate heat exchanger must be produced under vacuum conditions at very high temperatures and pressures over a very long period of time.

The object of the present invention is, therefore, to provide a solution which is more economical and still has such good heat exchange properties, such that it is suitable even for cooling hydrogen (or other fluids).

The invention achieves the stated object with the features of the main claim and is accordingly characterized in that the region around a heat exchanger tube for a first medium is provided by an open-pored, in particular solid, material, preferably a body of such a material (into which material the second medium in particular can enter).

It is thus provided according to the invention to fill the region (immediately) around the heat exchanger tube with an open-pored material.

In other words, the concept of the invention is that of embedding the heat exchanger tube in permeable material, through which a second medium in particular is able to flow.

In this way, the heat exchange properties of the heat exchanger according to the invention can be improved. In particular, the open-pored material, in contrast to the second medium, which in itself is volatile, provides a cold reservoir (or heat reservoir), which is able to cool (or heat) the heat exchanger tube in a particularly effective and/or long-lasting manner.

The second medium is in particular a refrigerant or a coolant.

Owing to the open-pored structure of the material, the second medium is able to enter into or flow through the material. With a closed-pored material, on the other hand, this would not be possible.

Accordingly, an open-pored material within the context of the invention is understood as being a material which has a large number of pores, at least some of which are connected, into which the second medium in particular can enter.

Owing to the open-pored structure (in contrast to a closed-pored form), the pores are for the most part not isolated from one another but are connected to other pores and/or to the outer side.

This form allows the second medium to flow through almost the whole of the region around the heat exchanger tube, even though this region is filled with a material that is actually solid.

The material is therefore in particular porous. However, porosity is not sufficient (because a closed-pored material can also have porosity). Instead, the material is thus also to be referred to as permeable.

The pores can have different shapes, for example fundamentally spherical pores (for example in the case of a foam-like material) or also pores in the form of narrow ribs, cracks or platelets or the like. It is important that the pores are substantially open and flow can thus take place through the material.

The open-pored material surrounds at least the active region of the heat exchanger tube, preferably completely.

This means in particular that the open-pored material is in direct contact with the outer side of the heat exchanger tube (optionally with the fins thereof).

Typically, the heat exchanger tube is located in a (solid) body of such an open-pored material.

In other words, the heat exchanger tube is enclosed in such a body or is encased in such a body.

The material is typically a solid material, that is to say a solid (for example not a body which has (low) viscosity). Only a solid form of the body allows sufficient storage of the cold/heat supplied by the second medium.

Typically, the second medium introduces cold into the material, or into the body.

However, the invention also includes applications in which the second medium is to introduce heat into the body in order to heat the first medium guided through the heat exchanger tube.

Such examples include the recovery of heat from exhaust gas. The first medium can be, for example, water and the second medium can be an exhaust gas. In such a case, the exhaust gas as the second medium can be introduced into the open-pored material, and the open-pored material releases the heat to the first medium (water) in the heat exchanger tube. The first medium guided in the heat exchanger is preferably cooled, however.

The first medium is in particular a fluid (that is to say a gas or a liquid). It can preferably be hydrogen, which in particular is to be cooled in the heat exchanger.

The second medium is preferably a coolant or refrigerant, for example a water/glycol mixture, CO2 gas or the like.

The second medium can thereby flow through the open-pored material or the body of the open-pored material, in particular transverse to or in the opposite direction to or in the same direction as the main direction of guiding of the first medium.

The open-pored material is solid in particular in the sense that it is to be solid in a finished, operational heat exchanger.

By contrast, during the production of the heat exchanger, the material can still be in a viscous or soft, and therefore non-solid, state.

In particular, the material does not even have to be open-pored (but can be closed-pored, for example) during the production of the heat exchanger. Thus, a non-solid, closed-pored foam could be introduced into the region around the heat exchanger tube, wherein the material subsequently hardens, dries or the like, whereby it achieves a substantially solid state. This state could in particular still be closed-pored. In this connection there are, however, possibilities for providing particles in the (not yet solid) material/foam prior to or during the introduction of the material into the region around the heat exchanger.

These particles can then be removed (for example washed out or the like) during or after hardening of the material.

Such particles can be salt crystals, for example.

As a result of these particles, the material finally acquires its open-pored structure, that is to say breaks open the closed pore structure of the material/foam. On the other hand, material that is open-pored from the outset can of course be introduced into the region around the heat exchanger. However, particular preference is given to an embodiment in which the particles define the main pores and smaller pores, which connect the large pores, are formed in a casting process.

In order to be able to adjust the heat exchanger that is produced for its later use, the porosity and/or permeability is to be adjustable during the production process. Merely by way of example, this can be controlled by the quantity or type of particles or by the type of starting material used (for example foam).

A type of production in which the heat exchanger tube is first introduced into a mold (of the casting die type) has been found to be particularly advantageous.

The material can in particular be a metal or an alloy.

Typically, the material is (die-)cast in a casting die.

The material can thereby be in the form of a melt, for example, and/or there can be particles in the material or the casting die, which particles can later be removed (in order to form the open pores).

The particles which can be introduced into the material can be crystals and/or powdered substances and/or plastic and/or liquid substances or the like, which are removable. These can have the same or different sizes at the micro and/or macro level.

Finally, it is important within the context of the invention that the particles in question define an open-pored structure in the target material.

A metal material has been found to be particularly suitable as the starting material. Such a material can in particular be aluminum or aluminum alloys.

In this context, the method for producing the open-pored material, or the open-pored material body, can be an open-pored aluminum die casting method.

On the other hand, a metal foam, in particular an aluminum foam, can of course also be introduced into the region around the heat exchanger. Here too, it is important that this foam is open-pored in its final state, which can be achieved in the case of aluminum foams, for example, by the addition of salt crystals or granules, which can then be washed out after the foaming process.

In principle, however, any other open-pored materials can also be used, in particular multifunctional and/or microstructured and/or microporous and/or activated and/or graded materials, in particular (micro)composite materials.

The material is preferably a material that is not open-pored in its basic state (for example, aluminum is not open-pored in its basic state).

The material is preferably processed and/or non-geological (layers of earth or rocks, for example, are not included in this advantageous embodiment).

The material of the heat exchanger is typically introduced into a mold or chamber in which the heat exchanger tube, or at least the active part of the heat exchanger tube, is located.

The mold or chamber can be the later housing of the heat exchanger, so that it can be provided, for example, with connections for the first and second media.

Alternatively, it could also be provided that said chamber or mold is subsequently removed and the heat exchanger tube, together with the open-pored material around it, is introduced into a completely different chamber or a different housing, which forms the housing of the later heat exchanger.

Finally, it is also conceivable that the heat exchanger tube, together with the open-pored material arranged around it, is not introduced into a chamber at all, but the second medium (flowing through the open-pored material) can be prevented from escaping by means of a coating of the open-pored material on the outer side.

The heat exchanger tube can be a conventional heat exchanger tube known from the field of heat exchanger technology. It can in particular be provided by a smooth tube or by a finned tube (that is to say a fin tube, wherein the fins are preferably welded (by means of a laser)).

The tube can be in an elongate, substantially linear form or in a form differing therefrom, typically in a spiral form. The form of a panel heat exchanger, that is to say a heat exchanger tube in the form of a meander or of a harp shape, is in principle included in the invention.

Finally, embodiments in which the heat exchanger tube is provided by a coaxial tube are also included in the invention.

It is a common feature of all the tube designs, however, that the tube is surrounded on its outer side by an open-pored material.

In particular in the case where the heat exchanger tube is in a spiral form, it can be provided that the spiral as a whole consists of more than one heat exchanger tube, for example of two substantially parallel heat exchanger tubes which have been shaped into a spiral form. In such an exemplary embodiment, both heat exchanger tubes would then be surrounded by the same open-pored material body.

In principle, it can thus be said that the heat exchanger can have more than one heat exchanger tube, which heat exchanger tubes are in particular embedded in the same material.

The heat exchanger tube can in this case typically consist of a metal, in particular copper, aluminum, stainless steel, titanium or the like, or alternatively of plastics material or another suitable material. If the tube has fins, these can consist of the same material or of a different (in particular metal) material.

Connections for the second medium can in particular be associated with the open-pored material body. Thus, an inlet for the second medium (in particular cooling medium) can be provided at one end of the body, and an outlet for that medium can be provided in the region of the other end of the body.

The first and/or second medium is advantageously a fluid, in particular in each case a gas or a liquid.

According to a particularly advantageous embodiment of the invention, the heat exchanger has a chamber in which the heat exchanger tube is arranged. In particular, at least the active part of the heat exchanger tube is arranged in the chamber. The active part of the heat exchanger tube means the part which is surrounded by the open-pored material and is typically cooled thereby, or by the second medium.

As already explained above, the chamber of the heat exchanger can be the production mold for the body of open-pored material, into which the base material is introduced during production of the heat exchanger, that is to say, therefore, a mold, casting mold or the like.

In this context, the chamber can in particular have a cover element (or cap), which has been closed in particular after introduction of the material.

Alternatively, the chamber can be a chamber other than a (casting) mold, for example a chamber into which the heat exchanger tube, together with open-pored material surrounding it, is introduced after it has been removed from the mold.

The chamber typically has at least one or more connections for the second medium, optionally also connections for the first medium (at least inasmuch as these are not provided by the heat exchanger tube itself, for example inasmuch as the heat exchanger tube protrudes from the chamber).

It is furthermore possible, as has likewise already been indicated above, that the chamber is provided by the outside wall of the body (of open-pored material), at least inasmuch as this is sealed or the like on the outer side.

It is preferably provided that the chamber is filled with the open-pored material. In particular, the chamber can be filled completely with the open-pored material. Alternatively, the chamber can also be only filled up or partly filled with the material.

According to a further, very advantageous embodiment of the invention, the chamber has a cross-section which tapers at least in some portions (preferably throughout).

Such a chamber can be thought of as a frustoconical chamber, for example, wherein a cone is here to be understood in the mathematical sense as being not only a geometric shape with a circular base but also any geometric shape with a polygonal base, for example a pyramid, or a truncated pyramid. It is a common feature of all these shapes that the cross-section tapers.

Such a tapering cross-sectional shape has the advantage that, when the second medium is correspondingly guided in the opposite direction through such a chamber, the second medium is able to expand, whereby further cooling effects occur. In other words, the second medium, which in particular is in the form of a coolant, can in principle cool down (further) as a result of expansion as it passes through the open-pored material body.

Accordingly, said cross-section should taper contrary to the main direction of flow of the second medium (that is to say of the coolant), so that the cross-section widens in the main direction of flow of the second medium and the medium is thus able to expand and cool down. This results in the controlled change of the pressure and temperature. Tapering of the cross-section is only one variant, other embodiments are also conceivable.

The chamber will, however, usually have a linear (non-tapering) cross-section.

The open-pored material advantageously consists of metal. In particular, it can be aluminum or an aluminum alloy, which is provided with open pores during the process of producing the heat exchanger. An open-pored aluminum foam or a cast aluminum body provided with open pores is thus conceivable.

According to a particularly advantageous embodiment of the invention, the heat exchanger tube can be in the form of a spiral. This makes possible a particularly compact construction of the heat exchanger. Other forms, as already indicated above, can, however, also be used.

According to an advantageous embodiment of the invention, the heat exchanger tube is in the form of a fin tube. The fins can be welded to the tube, for example, or rolled out, or the like, from the tube. They can be fins with different pitches or the same pitch.

The fins are likewise embedded in the open-pored material.

According to a further aspect of the invention, the invention relates to a method for producing a heat exchanger. As already described in part above, in the production of a heat exchanger according to the invention there is first provided a heat exchanger tube, which is introduced into a mold or chamber. Material is then introduced into the mold or chamber. The material can be, but does not have to be, already open-pored in the production state of the heat exchanger.

It is important that the material is open-pored in the later use state, that is to say after production of the heat exchanger.

Depending on the material, the material can be introduced into the chamber in different ways. Particular preference is given to a die casting method. Alternatively, however, the material can also be foamed, injected or admitted, or the like, into the chamber or mold.

It is particularly advantageously provided in the method according to the invention that particles have been or are added to the material which is to be introduced or has been introduced into the chamber.

The particles can be, for example, granules or crystals or the like, which are removed from the material after it has been introduced into the chamber.

For example, salt granules could be added to the material, which salt granules are washed out of the material after the material has been introduced into the mold or chamber. In principle, however, other possibilities for removing corresponding particles are also conceivable, such as, for example, heating or self-dissolution of the particles over time, or the like.

By the addition and later removal of such particles, an open-pored structure of the material can in particular be achieved, even in the case of materials which are not actually open-pored, such as molten metals, or even in the case of closed-pored materials such as, for example, foams.

Consequently, by means of such particles, a basic porosity of the material can be achieved (that is to say, the actual pores are formed). Alternatively or additionally, however, the connections or channels between the pores can also be produced by such particles. On the other hand, however, these can in turn also form (automatically) during a casting process.

In the case where the particles do not form the pores themselves by means of their removal but merely form connections, the pores themselves can be produced in any known way, for example by the addition of gases or liquids or the like to the starting material.

The particles can be added to the starting material before or after it is introduced into the chamber/mold or particularly preferably can be introduced into the chamber even before the material.

According to a further aspect of the invention, the invention relates to a system for refueling a vehicle with a gas, in particular hydrogen or autogas. Such systems can in particular comprise gas pumps or be in the form of gas pumps.

It should be noted at this point that the described fueling systems and methods can relate to any suitable gas, such as hydrogen, autogas, LNG, LPG or synthetic gases. In the following text, mention will in some cases be made specifically of hydrogen. However, instead of hydrogen, any other gases suitable for refueling, in particular the mentioned gases, are to be considered as also being disclosed.

In particular, such a system comprises a delivery nozzle by means of which the hydrogen can be introduced into the vehicle, or into the tank of the vehicle.

As already described, it is, however, necessary to reduce the temperature of the hydrogen before it is delivered into the tank, therefore to cool down the hydrogen, because the refueling operation is associated with a certain degree of compression and thus heating. The cooling operation is thus carried out in order to compensate for this heating.

For this cooling operation there is used a heat exchanger according to the invention, as has been described in detail above.

The heat exchanger can in particular be integrated in the gas pump. In particular, it can be arranged directly upstream of the nozzle and/or of a delivery hose associated therewith.

Such a delivery nozzle can also be referred to as or be part of a gun which, in particular together with a delivery hose, can be part of the system.

According to a final aspect of the invention, the invention relates to a method for refueling a vehicle with gas, in particular hydrogen, according to which hydrogen is guided from a hydrogen supply to a delivery nozzle, which is able to cooperate with the vehicle.

In particular, the delivery nozzle is able to cooperate with the tank of the vehicle, and it can in particular be arranged on a delivery hose.

For the purpose of cooling, the hydrogen is thereby guided through a heat exchanger arranged between the hydrogen supply and the delivery nozzle (and the delivery hose).

The heat exchanger is in particular arranged above the ground, further preferably in a gas pump.

The particular feature according to this aspect is that the hydrogen is guided through a heat-conducting tube of the heat exchanger and is thereby cooled.

Thus, the temperature of the hydrogen can be lowered in this way by at least 30° C., further advantageously by up to 150° C.

Merely by way of example, the temperature of the hydrogen can be lowered from approximately between 0° C. to 85° C. to approximately from −40° C. to −60° C. The coolant which is used for this purpose (that is to say the second medium within the meaning of the present application) can have a temperature of −50° C., for example.

In the prior art described at the beginning, cooling takes place in a very expensive plate heat exchanger.

Such a plate heat exchanger can be replaced according to the invention by a heat exchanger with a heat-conducting tube.

In this way, adaptation to a quantity of hydrogen typically required on average can in particular be achieved.

This has generally not been worthwhile for an expected lower number of delivery operations.

However, the method according to the invention, in which the hydrogen is guided through a heat-conducting tube of the heat exchanger and thereby cooled, now makes possible a considerable cost reduction and significantly lowers the inhibition threshold for the installation of a corresponding system.

The applicant has thereby found that, contrary to the prejudice that a plate heat exchanger is necessary for cooling hydrogen, such cooling is in fact also possible with a heat-conducting tube through which the hydrogen is guided.

The heat exchanger used in said method is particularly advantageously a heat exchanger described hereinbefore, in which the region around the heat exchanger tube is provided by or formed by an open-pored material.

All the remarks made in this connection are to apply analogously also to the method according to the invention which has just been described (and also to the method and system described before that). These advantages and features will not be repeated again at this point, simply for reasons of readability and economy.

Further advantageous embodiments of the invention will become apparent from the dependent claims which have not been cited and from the following description of the exemplary embodiments shown in the figures, in which:

FIG. 1 is a highly schematic view of a hydrogen filling station with a passenger car parked next to a hydrogen gas pump, with a heat exchanger according to the invention indicated by a broken line and an aluminum block of the prior art indicated by a broken line,

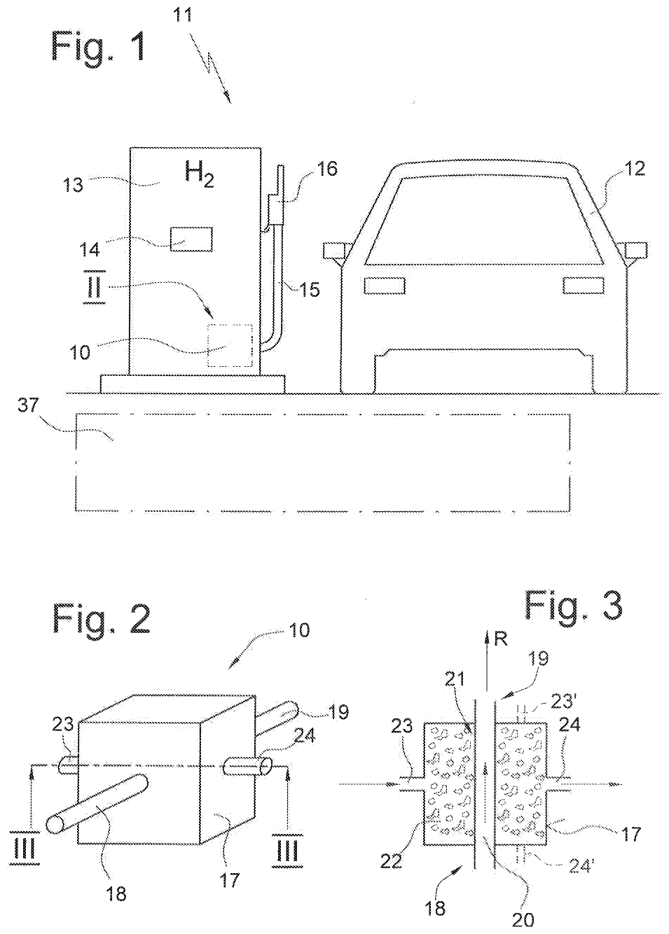

FIG. 2 is a highly schematic, isometric oblique view of a first exemplary embodiment of a heat exchanger according to the invention,

FIG. 3 is a highly schematic sectional view of the heat exchanger according to FIG. 2, approximately along section line III-III in FIG. 2,

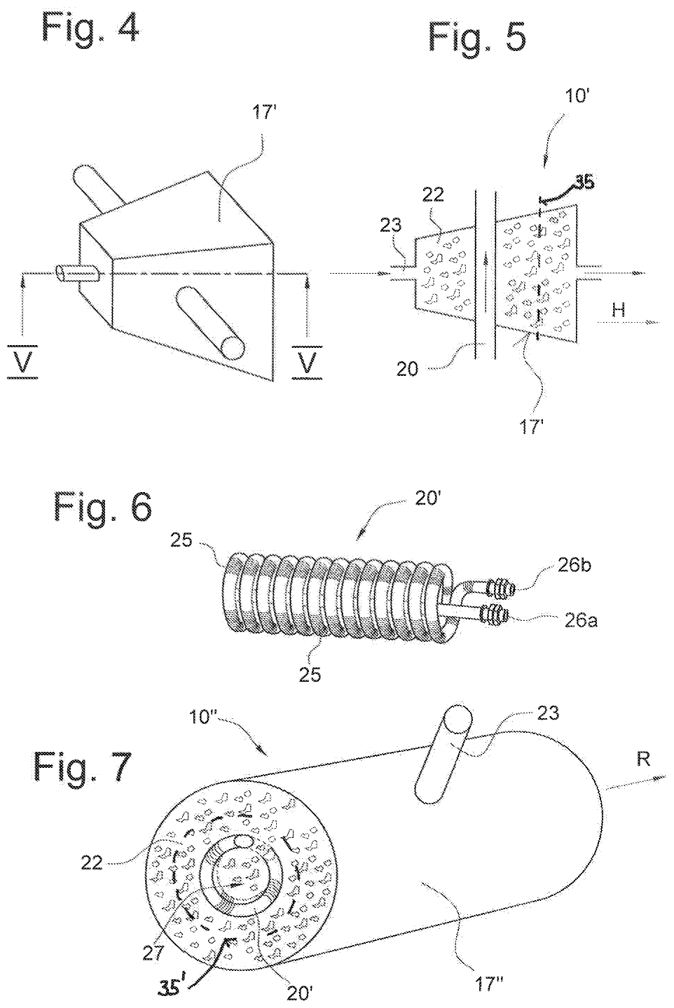

FIG. 4 shows, in a view which is approximately according to FIG. 2 but shifted through 90°, a further exemplary embodiment of a heat exchanger having a tapering chamber,

FIG. 5 shows, in a highly schematic view, a section through the heat exchanger according to FIG. 4, approximately along section line V-V in FIG. 4,

FIG. 6 shows an alternative exemplary embodiment of a heat exchanger tube of a heat exchanger according to the invention in a schematic, isometric oblique view,

FIG. 7 shows a further exemplary embodiment of a heat exchanger according to the invention having a heat exchanger tube according to FIG. 6, in a highly schematic, broken or truncated view,

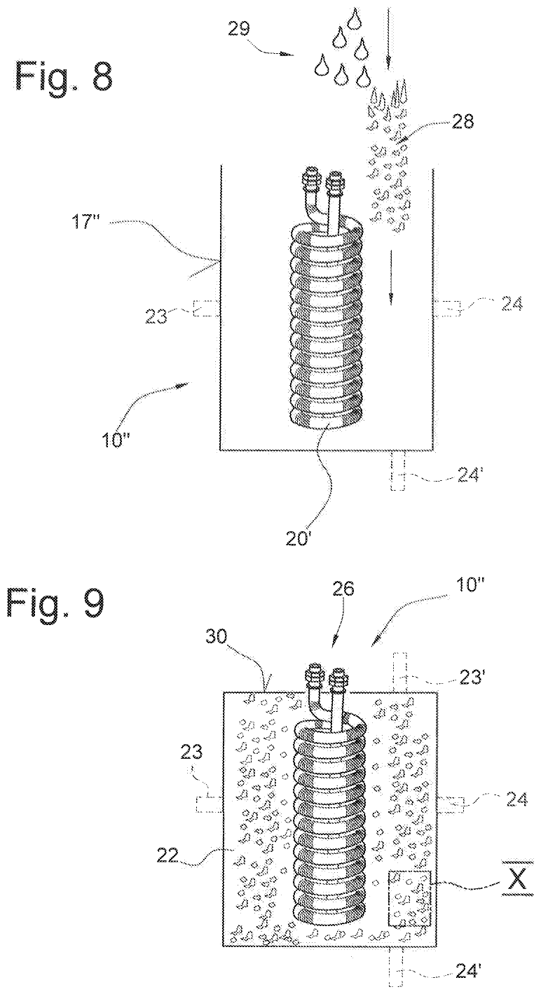

FIG. 8 shows, in a highly schematic illustration, the process of producing a heat exchanger according to the invention, in particular according to FIG. 7,

FIG. 9 shows, in a view according to FIG. 7, the finished heat exchanger according to FIG. 8, with the chamber closed, and

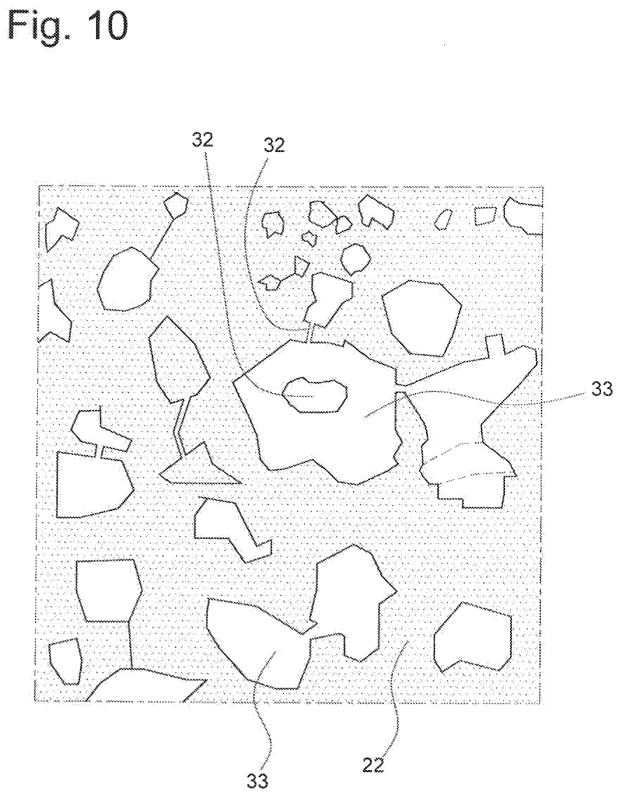

FIG. 10 shows a highly schematic detail of a piece of the open-pored material, for example according to window X in FIG. 9.

Exemplary embodiments of the invention are described by way of example in the following description of the figures, also with reference to the drawings. For the sake of clarity—also inasmuch as different exemplary embodiments are concerned—identical or comparable parts or elements or regions are thereby designated with identical reference numerals, in some cases with the addition of lowercase letters, numbers and/or apostrophes. The same applies to the claims following the description of the figures.

Within the scope of the invention, features which are described only in relation to one exemplary embodiment can also be provided in any other exemplary embodiment of the invention. Such modified exemplary embodiments—even if they are not shown in the drawings—are included in the invention.

All the disclosed features are in themselves essential to the invention. The disclosed content of the associated priority documents (copy of the preliminary application), where appropriate, and, where appropriate, also of the cited publications and of the described devices of the prior art is hereby incorporated in its entirety into the disclosure of the application, also for the purpose of incorporating individual or multiple features of these documents into one or into multiple of the claims of the present application.

FIG. 1 first shows a system 11 according to the invention for refueling a vehicle 12 with hydrogen.

The system 11 is by way of example in the form of a gas pump 13, which has, in addition to a display 14 and a delivery nozzle 16 (which can also be referred to as a coupling) connected by way of a hose 15 to the base body of the gas pump 13, in particular a heat exchanger 10 according to the invention, which is shown in FIG. 1 by a broken line.

The heat exchanger 10 is thereby arranged (directly) upstream of the hose 15, or the delivery nozzle 16, and is arranged upstream of a hydrogen supply (not shown in FIG. 1) (which can be integrated in the gas pump 13, for example, or can be arranged separately therefrom).

The heat exchanger 10 is therefore arranged between the hydrogen supply and the delivery nozzle 16.

In order to be able to refuel the vehicle 12 within a short period of time of typically less than 10 minutes, it is necessary to equalize the high temperatures which occur in the compression process during refueling and to reduce the temperature of the hydrogen in an upstream cooling process to approximately from −40° C. to −60° C. The heat exchanger 10 according to the invention, through which the hydrogen guided to the vehicle 12 flows, whereby it is cooled, serves precisely this purpose.

In FIG. 1, an aluminum block 37 of the prior art, which was mentioned in the introduction to the description, is shown by a broken line. However, such an aluminum block is no longer required in the case of the use of a heat exchanger 10 according to the invention. FIG. 1 is thereby intended to illustrate in particular the outlay which must in some cases still be made according to the prior art.

The particular feature of the heat exchanger 10 according to FIG. 1 consists, as is not yet shown in FIG. 1, however, in particular in that the hydrogen is guided through a heat exchanger tube of the heat exchanger 10 and is thereby cooled.

A very elaborate process of producing special plate heat exchangers, as has likewise been described at the beginning in relation to the prior art, can therefore be omitted.

FIG. 2 shows in this respect, in a highly exemplary form, in a highly schematic external oblique view, a first exemplary embodiment of a heat exchanger according to the invention, of which there can be seen in this figure, however, substantially only a chamber 17 (which can also be referred to as a housing). The chamber 17 has in particular two connections 18 and 19 (an inlet and an outlet) for hydrogen. The connections for a coolant are designated 23 and 24 in FIG. 2.

FIG. 3 is important, which shows a cross-section through the heat exchanger 10 according to FIG. 2, approximately along section line III-III in FIG. 2.

According to FIG. 3, the heat exchanger tube 20 is, purely by way of example, in the form of a smooth tube (that is to say without fins), which has a substantially linear, rod-like form. This is to be understood merely by way of example and is intended to illustrate the aspect of the invention according to the main claim.

Thus, it can be seen in FIG. 3 that the region 21 around the heat exchanger tube 20 (inside the chamber 17) is surrounded by an open-pored material 22. In the exemplary embodiment shown, the open-pored material 22 in particular fills the entire chamber 17.

The open-pored material 22 can be, for example, open-pored aluminum or another suitable material mentioned above.

It is decisive thereby that the material 22 has a certain permeability, that is to say an open-pored structure in the sense that the individual pores in the material 22, which are indicated in FIG. 3, are substantially connected together. This ensures that a coolant supplied by way of the connection 23 shown in FIG. 3 is able to flow through the open-pored material 22 (which is in the form of a solid body) from left to right in respect of FIG. 3, that is to say from the inlet/connection 23 to an outlet/connection 24, or from top to bottom (or vice versa) by way of the alternative (or additional) connections 23 and 24 indicated by a broken line. The cooling medium thereby in particular cools the open-pored material 22 (or the body thereof) and in this way also the heat exchanger tube 20, or the hydrogen guided in the tube, in the manner of a heat exchanger.

In relation to FIG. 3 it should finally be noted that it shows that the cooling medium is guided, by way of example, substantially transverse to the main direction of flow R of the hydrogen (through the chamber 17) (or, by way of the alternative connections indicated by a broken line, in or contrary to the main direction of flow R).

FIGS. 4 and 5 then show a second exemplary embodiment of a heat exchanger 10′ according to the invention, which is modified compared to the exemplary embodiment according to FIGS. 2 and 3 in only one aspect: Thus, the chamber 17′ in this exemplary embodiment is not cuboidal but has the form of a truncated pyramid.

This results, as is illustrated in particular in the sectional view according to FIG. 5, in a tapering of the chamber 17′ contrary to the main direction of flow H of the cooling medium. Consequently, the chamber 17′ widens in the main direction of flow H of the cooling medium.

Such a form of the chamber 17′, or of the body of the open-pored material 22, can lead to an additional cooling effect: Thus, the cooling medium can enter the heat exchanger 10′ by way of the inlet 23 and is then able to expand owing to the widening cross-sectional form of the chamber 17′ in the main direction of flow H of the cooling medium. In the case of gases, this expansion typically leads to a further cooling of the surroundings (because the gas is able to change its state of aggregation, or is able to evaporate, which leads to an evaporative cooling effect), which is able to additionally cool the open-pored material 22 (and thus the hydrogen).

However, cases are also conceivable in which the material 22 must not cool down too greatly (only, for example, in the case of a tapering cross-sectional form of the chamber). For such cases, FIG. 5 shows schematically a heating wire 35 which is embedded or cast in the material 22. The heating wire is shown only schematically and thus by a broken line and can have any desired shape (for example linear or meandering or spiral-shaped). It can in particular be provided with an electrical connection in order to provide the heat output. With such a heating wire 35, undesirable freezing in particular can be prevented.

FIG. 6 shows by way of example a heat exchanger tube 20′, which is not in the form of a smooth tube (there can be seen adumbrated fins 25—which for the sake of clarity are not throughout) and which is not in the form of a linear tube but in the form of a spiral tube, or is spiral-shaped.

Such a heat exchanger tube 20′ has the advantage that more active tube length can be arranged compactly in a smaller space.

However, in alternative exemplary embodiments it could also be a tube of flat, substantially planar harp or meander form, or tube bundles.

In any case, FIG. 6 shows by way of example two inlets or outlets 26 for the hydrogen. The inlets and outlets 26 thereby point by way of example in the same direction. The inlets and outlets 26 could of course also point in different directions, in particular be arranged at different ends of the spiral.

Such a heat exchanger tube 20′ according to FIG. 6 is installed by way of example in a further heat exchanger 10″ shown in FIG. 7.

In this exemplary embodiment, the chamber 17″ is, merely by way of example, of substantially cylindrical form, and the heat exchanger tube 20′ in this exemplary embodiment is oriented substantially coaxially, centrally.

According to this exemplary embodiment of the heat exchanger 10″ too, the heat exchanger tube 20′ is surrounded by open-pored material 22. The open-pored material 22 in particular again fills the entire chamber 17″ and extends in particular also into the inner region 27 of the spiral-shaped heat exchanger tube 20′.

FIG. 7 shows a broken, open sectional view, in particular because the open-pored material 22 can be seen, and the chamber 17″ would typically also be closed at the front, that is to say in the plane of view of FIG. 7.

Proceeding from FIG. 7, it should be noted that, in a different embodiment (not shown), it is possible that a separate chamber 17″ would not have to be provided at all, but the body of the open-pored material 22 could be coated or the like, for example, on its outer side (so that no coolant can leak). This would possibly even make a chamber unnecessary.

Like FIG. 5, FIG. 7 also shows, highly schematically, a heating wire 35′, which in this exemplary embodiment is arranged in the chamber 17″ in the form of a spiral, coaxially with the heat exchanger tube 20′.

Finally, it should also be noted in relation to FIG. 7 that the inlets or outlets 26 of the tube 20″ are concealed in this figure, because they point away approximately in a downward direction.

The sequence of figures of FIGS. 8 and 9 is intended to illustrate the process of producing a corresponding heat exchanger 10″ according to FIG. 7: Thus, FIG. 9 first shows a mold, which can be provided in particular by the chamber 17″. The heat exchanger tube 20′ is first introduced into this mold. The interior of the chamber 17″ is then filled with granules 28, which in FIG. 8 are indicated merely by way of example by a small number of granule particles.

A (metal) melt 29 is then introduced into the mold 17″, which is illustrated in FIG. 8, likewise by way of example, by a small number of melt drops. The melt 29 can thereby surround the granules 28 inside the chamber 17″ as well as the heat exchanger tube 20′.

After the melt 29 has solidified, the granules 28, which can be, for example, (NaCl) salt granules, can be flushed out or washed out, so that pores predominate in the material structure which is then formed. These pores are accordingly thus defined by the granules 28 as placeholders. Smaller connecting pores can form in particular as a result of the process of casting the melt 29.

Merely for the sake of completeness, it should be noted that other types of production are, however, also possible, that a foam, for example, can be introduced and the granules then define the connecting pores, or allow them to form.

In any case, there is formed in each case a configuration shown in FIG. 9 with the solid, open-pored material 22.

The chamber 17″ can then optionally be closed by a cover 30 or cap (which in particular takes account of the connections 26). This cover 30 can typically be very much smaller than shown in FIG. 9, in particular when the chamber 17″ is a casting mold. It can accordingly also be a closure element 30 instead of a cover.

In particular, the tube connections 26 can protrude through said cover. Alternatively, but not shown, one of the connections can, however, also be arranged oppositely, at the lower end in respect of FIG. 9, and/or can point in a different direction, for example can be guided through the base of the chamber.

It is also possible (but not shown) that the casting mold is removed completely and the structure so formed of material 22 and heat exchanger tube 20′ is then introduced into a separate chamber.

In any case, however, an open-pored structure is formed.

In the exemplary embodiment shown, the structure is by way of example an open-pored aluminum structure, which is shown again in FIG. 10 in an enlarged detail.

FIG. 10 shows in particular that there are in the open-pored material 22 larger pores 33, which are defined by the granules 28 and are formed by the removal thereof. Smaller connecting pores 32 can typically form as a result of the casting process (or alternatively or additionally can likewise be provided by granules of a different particle size or the like).

It is important in the present case that an open-pored material 22 is formed, which is permeable such that the coolant can be guided through this open-pored material 22.

Finally, it should be noted that, for the sake of clarity, FIG. 8 and FIG. 9 do not show a heating wire 35 or 35′ which is shown schematically in FIGS. 5 and 7. This could be either omitted or present (but not shown) in the exemplary embodiment. In the production of the heat exchanger according to FIG. 8 or FIG. 9, the heating wire can in particular be introduced into the chamber 17″ before the granules 28 and/or the melt 29 or—which is more practicable—after the granules 28 and/or the melt 29 (that is to say, therefore, as the final structural element).

1-11. (canceled)

12. A heat exchanger, comprising: a heat exchanger tube for guiding a first medium in its interior; and at least one connection for a second medium, wherein a region around the heat exchanger tube is provided by an open-pored material into which the second medium can enter.

13. The heat exchanger according to claim 12, wherein the material is a solid material.

14. The heat exchanger according to claim 12, wherein the material forms a body.

15. The heat exchanger according to claim 12, wherein The heat exchanger has a chamber in which the heat exchanger tube is arranged, wherein the chamber is filled with the open-pored material.

16. The heat exchanger according to claim 12, wherein the chamber is completely filled with the open-pored material.

17. The heat exchanger according to claim 15, wherein the chamber has a cross-section that tapers at least in some portions.

18. The heat exchanger according to claim 17, wherein the cross-section of the chamber tapers contrary to a main direction of flow of the second medium.

19. The heat exchanger according to claim 18, wherein the cross-section of the chamber is (frusto)conical.

20. The heat exchanger according to claim 12, wherein the material is metal, in particular aluminum.

21. The heat exchanger according to claim 20, wherein the material is aluminum.

22. The heat exchanger according to claim 12, wherein the heat exchanger tube is formed as a spiral and/or a fin tube and/or a coaxial tube.

23. The heat exchanger according to claim 12, further comprising a heating wire embedded in the material.

24. A method for producing a heat exchanger according to claim 1-2 having a heat exchanger tube for guiding a first medium in its interior, and at least one connection for a second medium, the method comprising the steps of: providing a heat exchanger tube in a mold or chamber, whcrcin the; and introducing a material, which is open-pored at least in a use state, is introduccd into the mold or chamber to provide a region around the heat exchanger tube into which the second medium can enter.

25. The method according to claim 24, wherein the material is (die-)cast, injected or foamed into the mold or container.

26. The method according to claim 24, including, for producing open porosity, removing particles from the material after the material has been introduced.

27. The method according to claim 26, including removing salt crystals.

28. A system for refueling a vehicle with a gas, comprising: a delivery nozzle: and a heat exchanger according to claim 12 arranged upstream of the delivery nozzle.

29. A method for refueling a vehicle with a gas, comprising guiding gas from a gas storage to a delivery nozzle that is able to cooperate with the vehicle, wherein the gas, for cooling purposes, is guided through a heat exchanger arranged between the gas storage and the delivery nozzle, wherein the gas is guided through a heat-conducting tube of the heat exchanger and is thereby cooled.

30. The method according to claim 29, wherein the heat exchanger has a heat exchanger tube for guiding a first medium in its interior, and at least one connection for a second medium, wherein a region around the heat exchanger tube is provided by an open-pored material into which the second medium can enter.
